(19) United States
(12) Patent Application Publication
(10) Pub. No.: US 2023/0333227 A1
(43) Pub. Date: Oct. 19, 2023

(54) DISTANCE MEASUREMENT SYSTEM, LIGHT EMITTING DEVICE, AND LIGHT RECEIVING DEVICE

(71) Applicant: FUJIFILM Business Innovation Corp., Tokyo (JP)

(72) Inventor: Daisuke IGUCHI, Kanagawa (JP)

(73) Assignee: FUJIFILM Business Innovation Corp., Tokyo (JP)

(21) Appl. No.: 17/978,949

(22) Filed: Nov. 1, 2022

(30) Foreign Application Priority Data
Apr. 15, 2022 (JP) 2022-067566

(51) Int. Cl. G01S 7/4915; G01S 7/481; G01S 7/4911; G01S 17/32

(52) U.S. Cl. CPC G01S 7/4915; G01S 7/4815; G01S 7/4911; G01S 7/4816; G01S 17/32

(57) ABSTRACT

A distance measurement system including: a light emitting unit that includes a first light emission section and second light emission section including light emitting elements; a drive unit that causes light of a first frequency to be emitted from the first light emission section and causes light of a second frequency to be emitted from the second light emission section; a light receiving unit that includes light receiving element, a first light reception section, and a second light reception section, the first light reception section including a light receiving element that receives at least the light of the first frequency, and the second light reception section including a light receiving element that receives at least the light of the second frequency; and a distance measurement unit that measures a distance from a target object from a time from reflection of light radiated from the light emitting unit by the target object to reception of the light by the light receiving unit, by a time-of-flight phase difference method.

### CROSS-REFERENCE TO RELATED APPLICATIONS

This application is based on and claims priority under 35 USC 119 from Japanese Patent Application No. 2022-067566 filed Apr. 15, 2022.

### BACKGROUND

### (i) Technical Field

The present invention relates to a distance measurement system, a light emitting device, and a light receiving device.

### (ii) Related Art

JP2019-219400A discloses a method of measuring a depth that is insensitive to damaged light due to in-plane reflection. The method includes causing a light source to radiate light to a scene, performing damaged light measurement by controlling a first charge storage unit of a pixel to collect charges based on light hit on the pixel during a first period in which the damaged light hits the pixel, but light returning from an object within the field of view of the pixel does not hit the pixel, removing a contribution from the damaged light from one or more measurements affected by the damaged light, based on the damaged light measurement, and determining the depth based on the one or more measurements in which the contribution from the damaged light has been removed.

JP2019-028039A discloses a distance measurement apparatus that includes a light projecting unit that projects light on a target object, a light receiving unit that receives light reflected or scattered by the target object, a scanning unit that scans the projected light on a scanning region, and a distance measurement unit that measures a time from light projection to light reception and measures a distance to the target object. In a case where one scanning is defined from scanning start in one division region among all a plurality of division regions obtained by dividing the scanning region to scanning end in all the division regions, the distance measurement apparatus determines whether or not a measurement value for a first division region is regarded as a measurement result for the first division region, based on the measurement value for the first division region, which has been measured by the distance measurement unit during one scanning, and a second measurement value for a second division region, which has been measured ahead of the first measurement value for the first division region. Then, the distance measurement apparatus outputs, as the distance to the target object, the measurement value for the first division region, which has been determined to be regarded as the measurement result.

JP2007-333592A discloses a distance measurement apparatus in which a light receiving unit 20 (light receiving lens 21) is disposed to be spaced from a light emitting unit 10 (light emitting lens 11), a light shielding plate 30 is provided at an edge of the light receiving lens 21 (light reception surface) on the light emitting unit 10 side, in a case where a distance at which received light intensity of scattered light by water droplets is equal to or less than a noise level of the light receiving unit 20 is set as d, an angle formed by an emission direction of search light by the light emitting unit 10 and a normal direction of the light reception surface is set as θ, and a lower limit of a deflection angle of scattered light converging in a specific direction is set as α, a shortest distance K from a center of the light emitting lens 11 to the edge of the light receiving lens 21 satisfies K≥d×sin 6°, and a diameter D of the light reception surface and a height L1 of the light shielding plate 30 are set to satisfy D/L1≤tan(α−θ).

### SUMMARY

There has been performed a technique of detecting a three-dimensional shape and the like of a target object by a distance measurement system that measures a distance to a target object by using the so-called time-of-flight (referred to as ToF below) method of measuring a time from light emission to reception of light reflected by the target object.

In the distance measurement system using the ToF method, a light emitting unit emits light to a target range of distance measurement, a light receiving unit receives reflected light, and the distance to the target object is measured for each of regions obtained by dividing the target range. In a distance measurement system using a phase difference method being the iToF method among such ToF methods, a light emitting unit emits light of a specific modulation frequency, and a light receiving unit receives light of a waveform of which the phase is shifted in accordance with the distance to a target object. Then, the distance to the target object is calculated from the phase of the waveform of the light received by a light receiving element of the light receiving unit. Here, in a case where the light emitting unit uniformly emits light to the entirety of the target range, there is a concern that distance measurement accuracy is deteriorated because a light receiving element of the light receiving unit receives reflected light or scattered light (so-called scattering and multipath noise) from the regions different from the corresponding region.

Aspects of non-limiting embodiments of the present disclosure relate to a distance measurement system, a light emitting device, and a light receiving device in which deterioration of distance measurement accuracy is suppressed as compared with a case of measuring a distance by emitting light at one frequency.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a distance measurement system including: a light emitting unit that includes a first light emission section and second light emission section including light emitting elements; a drive unit that causes light of a first frequency to be emitted from the first light emission section and causes light of a second frequency to be emitted from the second light emission section; a light receiving unit that includes light receiving element, a first light reception section, and a second light reception section, the first light reception section including a light receiving element that receives at least the light of the first frequency, and the second light reception section including a light receiving element that receives at least the light of the second frequency; and a distance measurement unit that measures a distance from a target object from a time from reflection of light radiated from the light emitting unit by the target object to reception of the light by the light receiving unit, by a time-of-flight phase difference method.

### BRIEF DESCRIPTION OF THE DRAWINGS

Exemplary embodiment(s) of the present invention will be described in detail based on the following figures, wherein:

FIG. 1 is a block diagram illustrating a schematic configuration of a light emitting device to which a first exemplary embodiment is applied, and a distance measurement system including the light emitting device;

FIG. 2 is a diagram illustrating a light emitting unit and a radiation surface from which light from the light emitting unit is emitted;

FIG. 3 is a diagram illustrating an example of the light emitting unit according to the first exemplary embodiment;

FIG. 4 is a diagram illustrating a light receiving unit;

FIGS. 5A and 5B are diagrams illustrating details of the light receiving unit according to the first exemplary embodiment: FIG. 5A is a diagram illustrating an example of the light receiving unit according to the first exemplary embodiment; and FIG. 5B is a diagram illustrating light received in a light reception section;

FIG. 6 is a diagram illustrating a path through which light emitted by the light emitting unit is received by the light receiving unit;

FIG. 7 is a timing chart illustrating noise in distance measurement based on a ToF method: (A) of FIG. 7 illustrates a timing of emitting light; (B) of FIG. 7 illustrates a timing of light reception in a case where there is no noise; (C) of FIG. 7 illustrates a timing of light reception in a case where noise is generated on a short-distance side; and (D) of FIG. 7 illustrates a timing of light reception in a case where noise is generated on a long-distance side;

FIG. 8 is a diagram illustrating an example of a light emitting unit according to a second exemplary embodiment;

FIG. 9 is a diagram illustrating an example of a light receiving unit according to the second exemplary embodiment;

FIGS. 10A and 10B are diagrams illustrating another example of the light emitting unit according to the second exemplary embodiment: FIG. 10A illustrates an example in which a certain light emission section and adjacent light emission sections in the x-direction and the y-direction emit light at different frequencies; and FIG. 10B illustrates an example in which a certain light emission section and surrounding light emission sections emit light at different frequencies;

FIG. 11 is a diagram illustrating an example of a light emitting unit according to a third exemplary embodiment; and

FIG. 12 is a diagram illustrating an example of a light emitting unit according to a fourth exemplary embodiment.

### DETAILED DESCRIPTION

Hereinafter, exemplary embodiments of the present invention will be described in detail with reference to the accompanying drawings.

A distance measurement system that measures the distance to a measurement target object based on a ToF method measures the distance to the measurement target object from a time from a timing at which light is emitted from a light emitting unit provided in the distance measurement system to a timing at which the emitted light is reflected by the measurement target object and then is received by a light receiving unit provided in the distance measurement system. The measurement of the distance by the distance measurement system may be referred to as “distance measurement”.

In such a distance measurement system, the three-dimensional shape (may be referred to as a “three-dimensional image” or a “3D shape”) of the measurement target object may be detected based on the measured distance. Measurement of a three-dimensional shape may be referred to as “three-dimensional measurement”, “3D measurement”, or “3D sensing” below.

In the following description, it is assumed that the distance measurement system performs distance measurement by the so-called iToF (indirect ToF) method. In the iToF method, light from the light emitting unit is radiated at a predetermined modulation frequency (the modulation frequency may be referred to as a frequency below). By demodulating light that has been reflected by the measurement target object and then received by the light receiving unit, the change in the phase of the light or the delay time from light emission to light reception is obtained, and thus distance measurement is performed.

### First Exemplary Embodiment

### Distance Measurement System 1

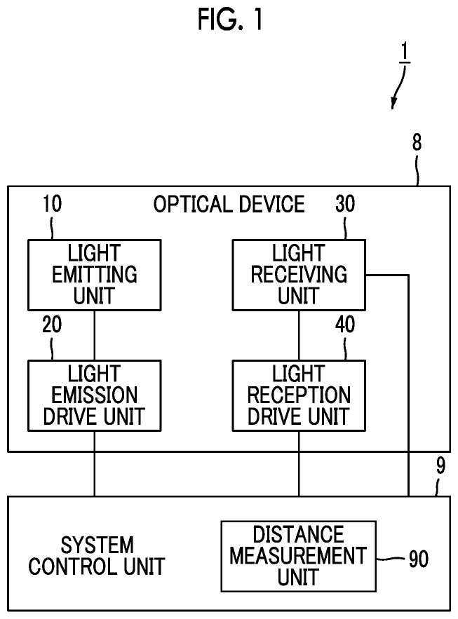

First, a first exemplary embodiment of the present invention will be described with reference to FIGS. 1 to 7.

FIG. 1 is a block diagram illustrating a schematic configuration of an optical device 8 to which the first exemplary embodiment is applied and a distance measurement system 1 including the optical device 8.

As illustrated in FIG. 1, the distance measurement system 1 includes the optical device 8 that emits light and receives light, and a system control unit 9 that controls the optical device 8.

The optical device 8 includes a light emitting unit 10 (an example of a light emitting device) that emits light by light emission of a VCSEL, a light emission drive unit 20 that drives the light emitting unit 10, a light receiving unit 30 (an example of a light receiving device) that receives the light reflected and returned by the measurement target object, and a light reception drive unit 40 that drives the light receiving unit 30.

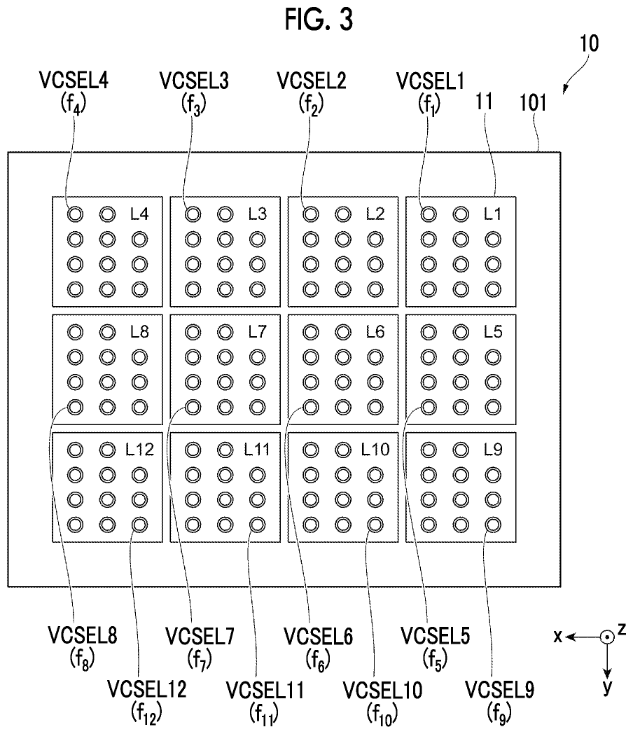

The light emitting unit 10 includes a VCSEL (described later with reference to FIG. 3) that is an example of a light emitting element, and is driven by the light emission drive unit 20 to emit light. More specifically, light is emitted from the light emitting unit 10 in a manner that the VCSEL is driven by a current supplied from the light emission drive unit 20 to emit light. The current that drives the VCSEL to emit light may be referred to as a “drive current” below.

The light emission drive unit 20 supplies the drive current to the light emitting unit 10 to drive the light emitting unit 10. More specifically, the light emission drive unit 20 emits the VCSEL by switching whether or not to supply a drive current in accordance with the control by the system control unit 9. The light emission drive unit 20 is an example of a drive unit.

The light emission drive unit 20 drives so that light radiated from the light emitting unit 10 is output at a plurality of frequencies. Various conventional methods are applied to a method of setting a plurality of frequencies of light. For example, different frequencies may be obtained by determining the modulation frequency using phase locked loop (PLL) or the like. In the present exemplary embodiment, light is emitted at the modulation frequency. Thus, the light emission is performed in a so-called pulse light emission manner in which light emission is repeatedly performed in a very short time.

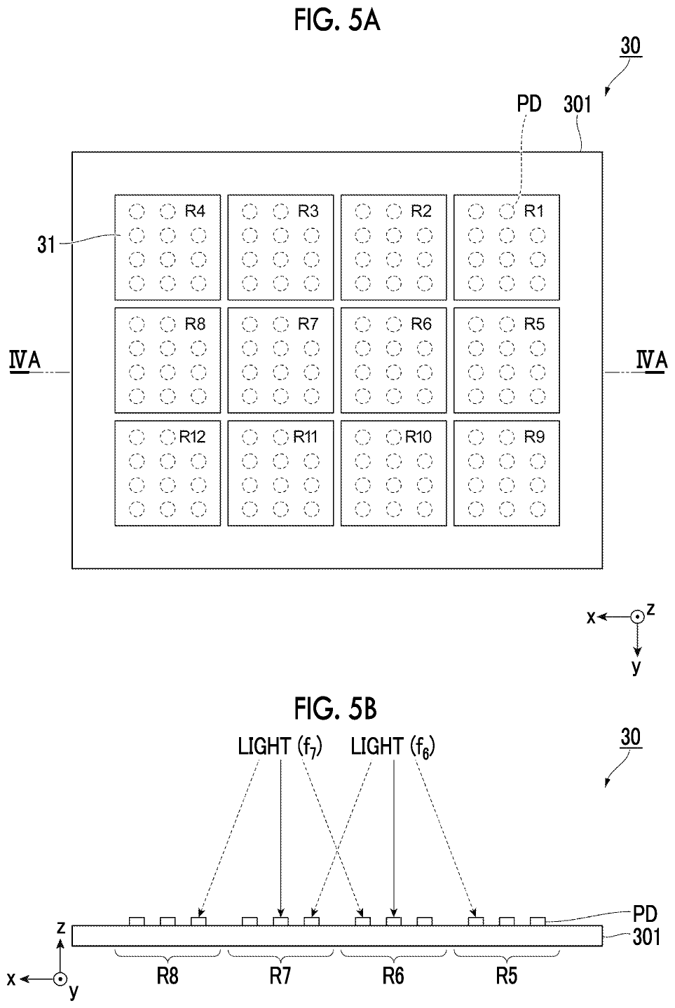

The light receiving unit 30 includes a photodiode PD (described later with reference to FIGS. 5A and 5B), which is an example of a light receiving element, and is driven by the light reception drive unit 40. In a case where light is received in a state where a photodiode PD is driven, an electric signal corresponding to the received light is transmitted as a light reception result.

The light reception drive unit 40 applies a voltage to the photodiode PD of the light receiving unit 30 to drive the light receiving unit 30. More specifically, the light reception drive unit 40 performs switching between light reception and non-light reception of the photodiode PD by switching whether or not to apply the voltage in accordance with the control by the system control unit 9.

The system control unit 9 transmits a control signal to the optical device 8 to control the optical device 8. More specifically, the system control unit 9 transmits control signals to the light emission drive unit 20 and the light reception drive unit 40 to control whether or not to drive the light emitting unit 10 and the light receiving unit 30.

The system control unit 9 further includes a distance measurement unit 90 that measures a distance to a measurement target object in accordance with a light reception result received from the light receiving unit 30. More specifically, the distance measurement unit 90 calculates the time Δt until light emitted from the light emitting unit 10 is reflected by a measurement target object and then is received by the light receiving unit 30, and calculates the distance to the measurement target object based on the time Δt.

The system control unit 9 is configured, for example, as a computer including a CPU, a ROM, a RAM, and the like. The ROM includes a non-volatile rewritable memory such as a flash memory. A program stored in the ROM is loaded into the RAM, and the CPU executes the program. In this manner, various functions such as the distance measurement unit 90 are realized.

Light Emitting Unit 10

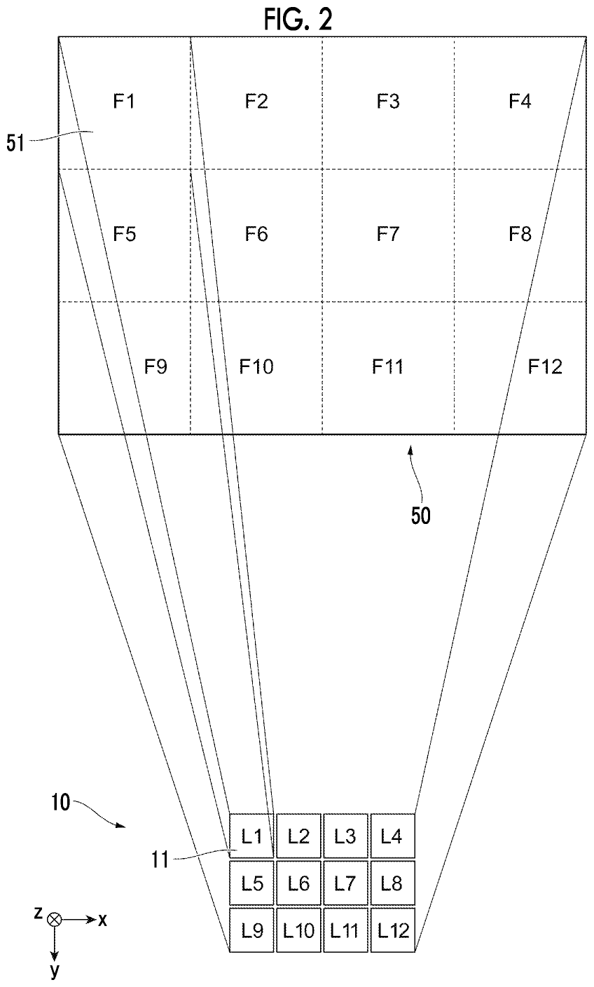

FIG. 2 is a diagram illustrating the light emitting unit 10 and a radiation surface 50 from which light from the light emitting unit 10 is emitted. In FIG. 2, the right side of the paper surface is set as a +x direction, the lower side of the paper surface is set as a +y direction, and the back side of the paper surface is set as a +z direction. Although the light emitting unit 10 and the radiation surface 50 are illustrated to be shifted in the up-down direction (±y direction) of the paper surface, the light emitting unit 10 and the radiation surface 50 are located to face each other. In FIG. 2, the light emitting unit 10 is located in the front side direction (−z direction) of the paper surface, and the radiation surface 50 is located in the back side direction (+z direction) of the paper surface.

Here, the front surface of the light emitting unit 10 is the surface on which the VCSEL is disposed and emits light. The back surface is the surface opposite to the surface from which the light is emitted. FIG. 2 illustrates a state in which the light emitting unit 10 is viewed from the back surface. VCSELs and the like are omitted, and only a light emission section 11 (described later) is illustrated.

The light emitting unit 10 includes a plurality of light emission sections 11 including at least one VCSEL on the front surface. Here, 12 light emission sections 11 being 4 in an x-direction and 3 in a y-direction are provided as an example. As illustrated in FIG. 2, in a case where it is necessary to distinguish the light emission sections 11 from each other, the light emission sections 11 are distinguished as light emission sections L1 to L12 in order from the upper left side (ends in the −x direction and the −y direction) in FIG. 2.

In the present specification, “to” indicates a plurality of constituent elements distinguished by numbers, and means that elements described before and after “to” and elements with numbers between the elements are included. For example, the light emission sections L1 to L12 include 12 light emission sections 11 from the light emission section L1 to the light emission section L12 in numerical order.

Each light emission section 11 is independently driven by the light emission drive unit 20 (see FIG. 1) to emit light. Driving the light emission section 11 means that power is supplied to the VCSEL provided in the light emission section 11, and thus the VCSEL emits light. Also, “independently driven” means that each light emission section 11 is driven. Therefore, all the light emission sections L1 to L12 do not necessarily simultaneously emit light. For example, the light emission section L1 may emit light while the light emission section L12 does not emit light.

The radiation surface 50 is a surface which is perpendicular to a direction in which light is radiated, at a certain distance in the direction in which the light is radiated from the light emitting unit 10. In addition, the radiation surface 50 is a surface from which light from the light emitting unit 10 is radiated. In the example in FIG. 2, the light emitting unit 10 radiates light in the +z direction. Thus, the radiation surface 50 extends in the x-direction and the y-direction at a certain distance in the +z direction.

In the first exemplary embodiment, the radiation surface 50 has a rectangular shape corresponding to the point that the light emission sections 11 of the light emitting unit 10 are arranged in a rectangular shape.

As illustrated in FIG. 2, the radiation surface 50 is divided into a plurality of radiation sections 51 corresponding to the light emission sections 11 of the light emitting unit 10. In the example in FIG. 2, the radiation surface 50 is divided into 12 radiation sections 51 being 4 in the x-direction and 3 in the y-direction. In a case where it is necessary to distinguish the radiation sections 51 from each other, the radiation sections 51 are distinguished as radiation sections F1 to F12 in order from the upper left side (ends in the −x direction and −y direction) in FIG. 2.

A light emission section Li to which the same number i as the number of a certain radiation section Fi is assigned may be referred to as a “corresponding light emission section”. For example, the light emission section L1 is a light emission section corresponding to the radiation section F1. Conversely, a radiation section Fi to which the same number i as the number of a certain light emission section Li is assigned may be referred to as a “corresponding radiation section”.

The radiation sections F1 to F12 have an arrangement symmetrical about an xy plane with the light emission sections L1 to L12. For example, the radiation sections F1, F2, F3, and F4 are arranged in this order in the +x direction, corresponding to the light emission sections L1, L2, L3, and L4 being arranged in this order in the +x direction.

Each light emission section 11 emits light towards the corresponding radiation section 51. Light from the corresponding light emission section 11 to each radiation section 51. Here, the point that the light emission section 11 radiates light toward the corresponding radiation section 51 means that the optical axis of the light emitted from the light emission section 11 is directed to the corresponding radiation section 51. Such a point is not limited to a state where the entirety of light from a certain light emission section 11 enters into the corresponding radiation section 51 and a state where only light from the corresponding light emission section 11 is entered into a certain radiation section 51. Thus, light from other light emission sections 11 different from the corresponding light emission section 11 may enter into the radiation section 51.

In the optical device 8, light from the light emitting unit 10 is spread in a direction intersecting with a direction (+z direction) in which light is radiated, by an optical member (not illustrated) and radiated to the radiation surface 50. As the optical member, a diffusion plate that is provided on the path of light and diffuses light by scattering or the like, a diffractive optical element (DOE) that changes the angle of incident light and outputs the light, and/or a lens or the like may be used.

FIG. 3 is a diagram illustrating an example of the light emitting unit 10 according to the first exemplary embodiment, and illustrates a state of the light emitting unit 10 viewed from the front surface. In FIG. 3, the left side of the paper surface is the +x direction, the lower side of the paper surface is the +y direction, and the front side of the paper surface is the +z direction.

As illustrated in FIG. 3, the light emitting unit 10 includes a substrate 101 and the light emission section 11 including the VCSEL. More specifically, the light emission sections 11 are provided to be stacked on the substrate 101 in the direction (+z direction) in which light is radiated.

A plurality of VCSELs are arranged in each light emission section 11. In the example in FIG. 3, the number of VCSELs in each of all the light emission sections 11 is equal, and 11 VCSELs are provided in each light emission section 11. The number of VCSELs in the light emission section 11 is not limited, and may be changed in accordance with the required amount of light and the like.

The VCSEL arranged in each light emission section 11 is denoted by the same number i as the number of the light emission section Li to be distinguished as a VCSELi. For example, in FIG. 3, 11 pieces of VCSEL1 are arranged in the light emission section L1.

In the light emitting unit 10 according to the first exemplary embodiment, a VCSEL arranged in a certain light emission section 11 and a VCSEL arranged in an adjacent light emission section 11 emit light of different frequencies. That is, in the light emitting unit 10, a certain light emission section 11 and an adjacent light emission section 11 emit light of frequencies different from each other. The term “adjacent light emission section 11” refers to light emission sections 11 that are aligned with a certain light emission section 11 without another light emission section 11 interposed. For example, in FIG. 3, a light emission section L7 and a light emission section L6 adjacent in the −x direction emit light of frequencies different from each other. Also, for example, the light emission section L7 and the light emission section L3 adjacent in the −y direction emit light of frequencies different from each other.

More specifically, in the light emitting unit 10 according to the first exemplary embodiment, all the light emission sections 11 emit light of different frequencies, so that the adjacent light emission sections 11 emit light of different frequencies.

Here, as illustrated in FIG. 3, the frequency of light emitted by each light emission section 11 is denoted by the same number i as the number of the light emission section Li, and is described as a frequency fi for distinguishment. In the example of FIG. 3, the light emission sections L1 to L12 of the light emitting unit 10 emit light of different frequencies f1 to f12. All frequencies of light emitted by the light emitting unit 10 may be referred to as a frequency f without distinguishing between the frequencies. The frequency f1 is an example of a first frequency in the present exemplary embodiment, and is a modulation frequency.

As described above, the light emitting unit 10 includes a first light emission section and a second light emission section. The first light emission section includes a light emitting element that emits light at a first frequency. The second light emission section includes a light emitting element that emits light at a second frequency. For example, the light emitting unit 10 includes the light emission section L6 that emits light at a frequency f6 and the light emission section L7 that emits light at a frequency f7. The frequencies f1 to f12 are examples of the first and second frequencies, respectively. The light emission sections L1 to L12 are examples of the first and second light emission sections, respectively.

Here, the frequency of light emitted by each light emission section 11 is adjusted by a modulation unit provided in the light emission drive unit 20. More specifically, the light emission drive unit 20 according to the first exemplary embodiment is configured by a set of light emission drive units 20-i (not illustrated) for independently driving the light emission sections Li. Each light emission drive unit 20-i causes the modulation unit to modulate a frequency f0 to a predetermined frequency fi, and drives each light emission section Li to emit light. For example, in the example of FIG. 3, the light emission drive unit 20-1 changes the light emission section L1 from the frequency f0 to a predetermined frequency f1, and drives the light emission section L1 to emit light of the frequency f1.

The light emission section Li includes a connection terminal (not illustrated) connected to the light emission drive unit 20-i.

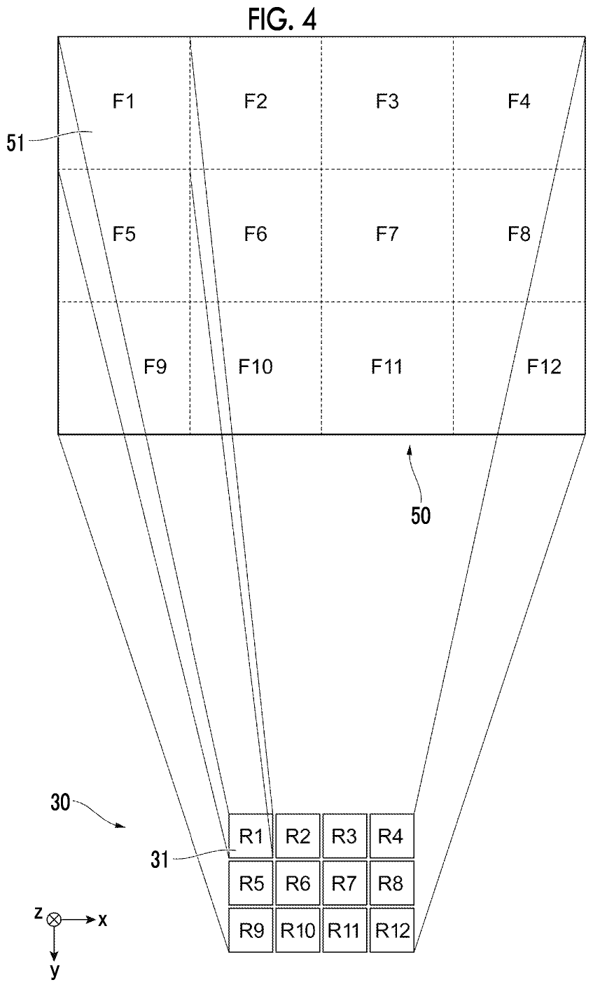

FIG. 4 is a diagram illustrating the light receiving unit 30. In FIG. 4, the right side of the paper surface is the +x direction, the lower side of the paper surface is the +y direction, and the back side of the paper surface is the +z direction. Although the light receiving unit 30 and the radiation surface 50 are illustrated to be shifted in the up-down direction (±y direction) of the paper surface, the light receiving unit 30 and the radiation surface 50 are located to face each other. In FIG. 4, the light receiving unit 30 is located in the front side direction (−z direction) of the paper surface, and the radiation surface 50 is located in the back side direction (+z direction) of the paper surface.

Here, the front surface of the light receiving unit 30 is the surface on which the photodiode PD is arranged and receives light. The back surface is the surface opposite to the surface on which the light is received. FIG. 4 illustrates a state in which the light receiving unit 30 is viewed from the back surface. Also, the photodiode PD and the like are omitted, and only the light reception section 31 (described later) is illustrated.

The light receiving unit 30 includes a light reception section 31 including at least one photodiode PD.

The light reception sections 31 are provided corresponding to the radiation sections 51 of the radiation surface 50. In the example in FIG. 4, 12 light reception sections 31 being 4 in the x-direction and 3 in the y-direction are provided corresponding to the 12 radiation sections 51. In a case where it is necessary to distinguish the light reception sections 31 from each other, the light reception sections 31 are distinguished as light reception sections R1 to R12 in order from the upper left side (ends in the −x direction and −y direction) in FIG. 4.

A light reception section Ri to which the same number i as the number of a certain light emission section L1 and a certain radiation section Fi are assigned may be referred to as a “corresponding light reception section”. For example, the light reception section R1 is a light reception section corresponding to the light emission section L1 or the radiation section F1. Conversely, the light emission section Li to which the same number i as the number of a certain light reception section Ri is assigned may be referred to as a “corresponding light emission section”, and the radiation section Fi to which the same number is assigned may be referred to as a “corresponding radiation section”.

The light reception sections R1 to R12 have an arrangement symmetrical about the xy plane with the corresponding radiation sections F1 to F12. For example, the light reception sections R1, R2, R3, and R4 are arranged in this order in the +x direction, corresponding to the radiation sections F1, F2, F3, and F4 being arranged in this order in the +x direction.

Each light reception section 31 is independently driven by the light reception drive unit 40 (see FIG. 1) to perform a light reception operation. Driving the light reception section 31 means changing the photodiode PD in the light reception section 31 from a state in which it is not possible to receive light to a state in which light can be received and an electric signal (light reception result) can be output. Further, “independently driven” means that each light reception section 31 is driven.

FIGS. 5A and 5B are diagrams illustrating details of the light receiving unit 30 according to the first exemplary embodiment. FIG. 5A is a diagram illustrating an example of the light receiving unit 30 according to the first exemplary embodiment. FIG. 5B is a diagram illustrating light received in the light reception section 31. FIG. 5A illustrates a state of the light receiving unit 30 viewed from the front surface. The left side of the paper surface is the +x direction, the lower side of the paper surface is the +y direction, and the front side of the paper surface is the +z direction. FIG. 5B corresponds to the IVA-IVA cross section in FIG. 5A. The left side of the paper surface is the +x direction, the front side of the paper surface is the +y direction, and the upper side of the paper surface is the +z direction.

As illustrated in FIG. 5A, the light receiving unit 30 includes a substrate 301 and the light reception section 31 including a photodiode PD. More specifically, the light reception sections 31 are provided to be stacked on the substrate 301 in the +z direction.

Each light reception section 31 includes a plurality of photodiodes PD. More specifically, in each light reception section 31, the photodiode PD is arranged in the +z direction with respect to the substrate 301.

In the example in FIG. 5A, the number of photodiodes PD in each of all the light reception sections 31 is equal, and 11 photodiodes PD are provided in each light reception section 31. The number of photodiodes PD is not limited to this, and may be changed in accordance with the area of the light reception section 31 or the like.

Here, in the light receiving unit 30, the result obtained by receiving light of a predetermined frequency for each light reception section 31 is output as a light reception result. More specifically, the photodiode PD of each light reception section 31 receives light regardless of the frequency of the entering light, but the phase with respect to an optical signal having a signal component captured in synchronization with the light of a frequency f radiated from the corresponding radiation section 51 is output as the light reception result. Light of other frequencies acts on both the phases of the frequencies of the light originally intended to be received. Therefore, the other frequency components are superimposed as neutral noise on the time domain, and the influence of the light of other frequencies becomes negligible during the calculation by the phase difference method. As the light reception result, only the result obtained by receiving the light of the frequency f radiated to the corresponding radiation section 51 is output. In the first exemplary embodiment, a result obtained by receiving the light of the frequency f, which is radiated from the corresponding radiation section 51 by the corresponding light emission section 11 is output as the light reception result of each light reception section 31.

That is, the light reception section Ri outputs, as the light reception result, a result obtained by receiving the light of the frequency fi allocated in advance in response to the light radiated to the corresponding radiation section Fi.

For example, as illustrated in FIG. 5B, in a case where light of frequencies f6 and f7 are reflected by the light reception sections R5 to R8, the photodiode PD in the light reception section R6 receives the light of the frequency f6 (solid arrow) and the light of the frequency f7 (broken arrow). The phase of the light of the frequency f7 is superimposed on the phase of the light of the frequency f6. As a result of the calculation of the phase difference method, only the result obtained by receiving the light of the frequency f6 is output as the light reception result of the light reception section R6. Similarly, the photodiode PD in the light reception section R7 receives the light of the frequency f6 (solid line arrow) and the light of the frequency f7 (broken line arrow), but only the result obtained by receiving the light of the frequency f7 is output as the light reception result of the light reception section R7.

As described above, the light receiving unit 30 includes a first light reception section for receiving light of the first frequency and a second light reception section for receiving light of the second frequency. For example, the light receiving unit 30 includes the light reception section R6 for receiving light of the frequency f6 and the light reception section R7 for receiving light of the frequency f7. The light reception sections R1 to R12 are examples of the first light reception section and the second light reception section.

As described above, in the distance measurement system 1 to which the first exemplary embodiment described with reference to FIGS. 1 to 5 is applied, in measurement, all the light emission sections 11 of the light emitting unit 10 are simultaneously driven by the light emission drive unit 20 to emit light and radiate the light to the radiation surface 50. All the light reception sections 31 of the light receiving unit 30 are simultaneously driven by the light reception drive unit 40 to receive the light reflected by the target object on the radiation surface 50. The distance to the target object is measured from the time until the light emitting unit 10 emits light and the light receiving unit 30 receives the light.

In addition, the light emission drive unit 20 drives all the light emission sections 11 of the light emitting unit 10 to emit light during the same period. That is, all the light emission sections 11 are driven so that a timing at which the light emission sections 11 start light emission and a timing at which the light emission sections 11 stop light emission are equal to each other.

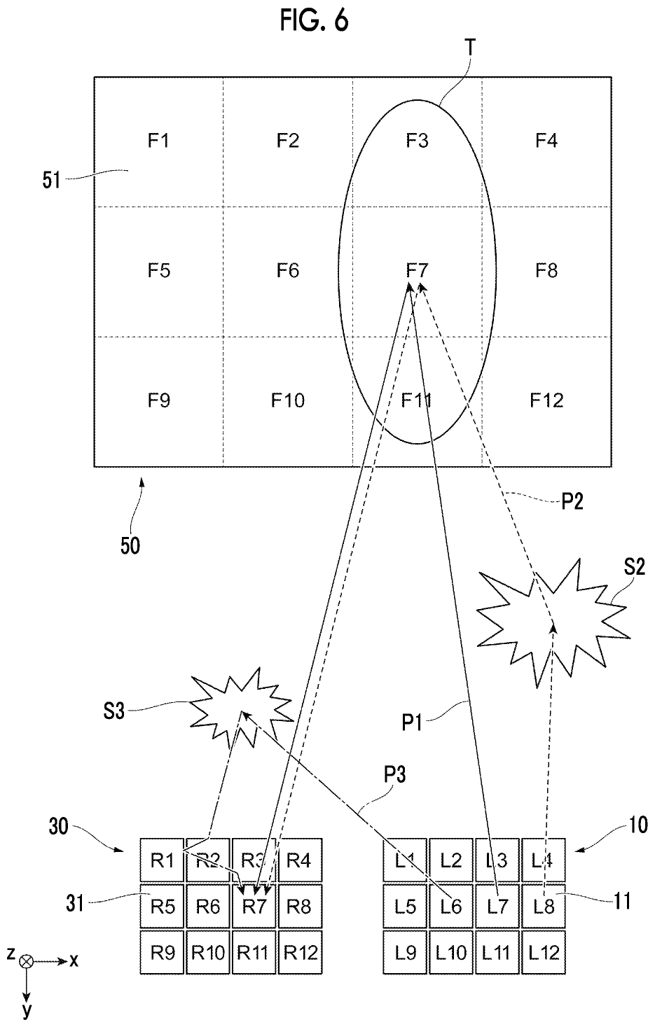

Here, noise generation in distance measurement based on the ToF method will be described with reference to FIG. 6.

FIG. 6 is a diagram illustrating a path of light emitted from the light emitting unit 10 until the light is received by the light receiving unit 30. FIG. 6 illustrates a state where a three-dimensional shape is measured by measuring the distance to a measurement target object T located on the radiation surface 50. In FIG. 6, the right side of the paper surface is the +x direction, the bottom side of the paper surface is the +y direction, and the back side of the paper surface is the +z direction. FIG. 6 illustrates the light emitting unit 10, the light receiving unit 30, and the radiation surface 50 so that the light emitting unit 10 and the light receiving unit 30 are shifted from the radiation surface 50 in the up-down direction (±y direction) of the paper surface. FIG. 6 illustrates the light emitting unit 10 and the light receiving unit 30 to be shifted in the left-right direction (±x direction) of the paper surface.

In the example in FIG. 6, the measurement target object T is located in the radiation sections F2 to F4, F6 to F8, and F10 to F12 on the radiation surface 50. In this case, for example, the distance to the measurement target object T in the radiation section F7 is calculated based on a light reception result obtained by receiving light in the light reception section R7 of the light receiving unit 30. Similarly, the distance to the measurement target object T is measured by calculating the distances to the measurement target object T in the radiation sections F2 to F4, F6, F8, and F10 to F12 based on the light reception results of the light reception sections R2 to R4, R6, R8, and R10 to R12.

In the measurement, the distance to the target object is calculated assuming that the light reception result in a certain light reception section Ri is obtained by receiving light that is radiated to the corresponding radiation section Fi by the corresponding light emission section Li and then is reflected by the target object. For example, the measurement is performed assuming that the light reception result in the light reception section R7 in FIG. 6 is obtained by receiving the light that is radiated to the radiation section F7 by the light emission section L7, and then is reflected by the measurement target object T, as indicated as a path P1 indicated by the solid arrow.

Here, there is a probability that light enters into the light reception section R7 through a path different from the path P1.

For example, an object S2 having high reflectance may exist in front of the measurement target object T. In this case, as indicated by the broken line arrow, there is a probability that light that is radiated by the light emission section L8 adjacent to the light emission section L7 and then is reflected by the object S2 enters into the radiation section F7, is reflected again by the measurement target object T, and then enters into the light reception section R7. In other words, there is a probability that the light having passed through a path P2 which is longer than the path P1 enters into the light reception section R7.

Further, for example, in a case where an object S3 having high reflectance exists, as indicated by an arrow of a one-dot chain line, there is a probability that light that is radiated by the light emission section L6 and then is reflected by the object S3 is reflected a plurality of times in the light receiving unit 30, and then enters into the light reception section R7. That is, there is a probability that the light that has passed through a path P3 that is shorter than the path P1 enters into the light reception section R7.

In addition, the light from the light emission sections L3, L6, L8, and L11 adjacent to the corresponding light emission section L7 enters into the light reception section R7 more easily than the light from the light emission sections 11 that are not adjacent, such as the light emission section L1.

In a case where light on a path different from the path P1 enters into the light reception section R7 as described above, a distance measurement system (referred to as a “conventional distance measurement system” and to distinguish the conventional distance measurement system from the conventional distance measurement system in the present exemplary embodiment by adding “′” to each constituent unit) 1′ to which the present exemplary embodiment is not applied, noise occurs in the light reception result. Here, the conventional distance measurement system 1′ is different from the distance measurement system 1 to which the present exemplary embodiment is applied, in that all light emission sections 11′ of a light emitting unit 10′ radiate light of the same frequency and all light reception sections 31′ of a light receiving unit 30′ receive light of the same frequency. That is, in the conventional distance measurement system 1′, the light emission section 11′ of the light emitting unit 10′ radiates light of one (common) frequency. Each light reception section 31′ of the light receiving unit 30′ is in a state capable of receiving even light radiated from any light emission section 11′ without distinguishing rays of light from each other.

Therefore, in the conventional distance measurement system 1′, since all light emission sections 11 radiate light of the same frequency, and all light reception sections 31′ receive light of the same frequency, a photodiode PD′ receives all rays of light entering into the light reception section R7′ regardless of a path through which the light has passed. Then, the light that has passed through other paths longer or shorter than the path P1 is received by a light reception section R7′ and acts as noise in the light reception result.

On the other hand, in the distance measurement system 1 to which the first exemplary embodiment is applied, only the result obtained by receiving the light of the frequency f7 among rays of the light entering into the light reception section R7 is output as the light reception result of the light reception section R7. That is, in the first exemplary embodiment, only the result obtained by receiving the light of the frequency f7 emitted from the light emission section L7 is output as the light reception result of the light reception section R7. Conversely, the light of the frequencies f6 and f8 emitted from the light emission sections L6 and L8 is not output as the light reception result regardless of being received by the photodiode PD. Therefore, in the distance measurement system 1 to which the first exemplary embodiment is applied, not only the result obtained by receiving the light that has passed through the path P1 is selectively used, but also an occurrence of a situation in which the light reception result includes the result obtained by receiving light that has passed through the other paths such as the paths P2 and P3 is suppressed, and generation of noise in the light reception result is suppressed in comparison to the conventional distance measurement system 1′.

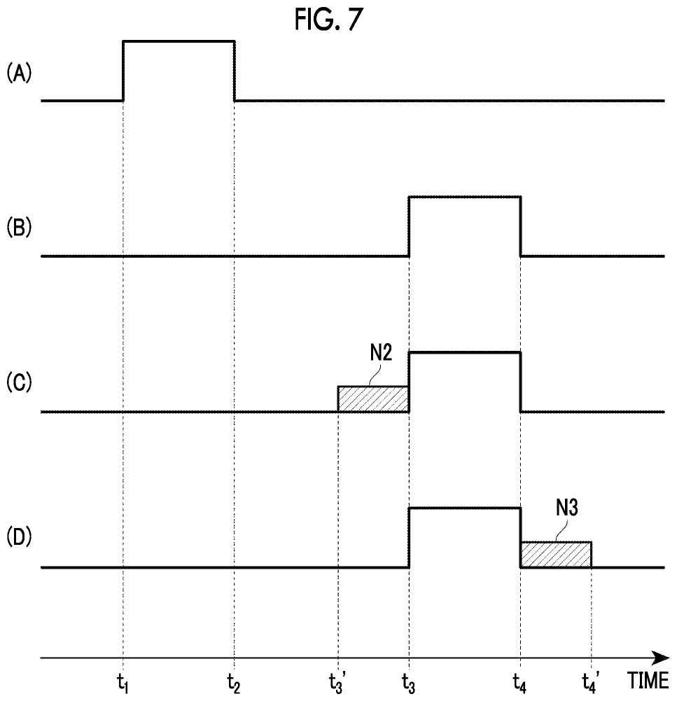

Next, an influence of noise on distance measurement based on the ToF method will be described with reference to FIG. 7.

FIG. 7 is a timing chart illustrating noise in distance measurement based on the ToF method. (A) of FIG. 7 illustrates a timing of emitting light. (B) of FIG. 7 illustrates a timing of light reception in a case where there is no noise. (C) of FIG. 7 illustrates a timing of light reception in a case where noise N2 is generated on a short-time side (a short-distance side). (D) of FIG. 7 illustrates a timing of light reception in a case where noise N3 is generated on a long-time side (a long-distance side). The horizontal axis represents the time.

Here, similarly to FIG. 6, light reception in the light reception section R7 will be described as an example.

First, as illustrated in (A) of FIG. 7, the light emitting unit 10 or 10′ emits light between time points t1 and t2. After the elapse of the time corresponding to the distance to the measurement target object T, the light is received by the light receiving unit 30 or 30′. Here, in a case where only the light that has passed through the path P1 is received in the light reception section R7, as illustrated in (B) of FIG. 7, light reception is assumed to be performed between time points t3 and t4. At this time, the distance to the measurement target object T is obtained in accordance with the difference between the time points t1 and t2, and the time points t3 and t4.

As described above, in the conventional distance measurement system 1′, all rays of light including light that has passed through a path different from the path P1 are received in the light reception section R7′. Then, in a case where light that has passed through a path shorter than the path P1, such as the path P3 in FIG. 6, enters into the light reception section R7′, as illustrated in (C) of FIG. 7, light reception is performed at a time point t3′ earlier than the time point t3, and the light reception result includes the noise N2 on the short-time side (short-distance side). For example, in a case where light that has passed through a path longer than the path P1, such as the path P2 in FIG. 6, enters into the light reception section R7′, as illustrated in (D) of FIG. 7, light reception is performed at a time point t4′ delayed from the time point t4, and the light reception result includes the noise N3 on the long-time side (long-distance side). Since the distance to the measurement target object T is measured in accordance with the light reception result including the noise N2 and the noise N3, the distance measurement accuracy is deteriorated as compared to a case where the light reception result includes only the result obtained by receiving the light that has passed through the path P1.

On the other hand, in the distance measurement system 1 to which the first exemplary embodiment is applied, the result obtained by receiving the light that has passed through the path P1 is selectively output as the light reception result of the light reception section R7. Thus, the generation of the noise N2 and the noise N3 is suppressed. Therefore, in the distance measurement system 1, deterioration in distance measurement accuracy is suppressed as compared with the conventional distance measurement system 1′.

The example in FIGS. 2 to 6 is configured such that the 12 light emission sections L1 to L12 of the light emitting unit 10 emit light of different frequencies f1 to f12, and the result obtained by receiving light of each frequency is selectively output as the light reception result of the corresponding light reception section among the light reception sections R1 to R12. However, in the first exemplary embodiment, the light emission sections 11 of the light emitting unit 10 only need to emit light of different frequencies, and the number of light emission sections 11 and the number of frequencies used for light emission are not limited. The light reception sections 31 of the light receiving unit 30 may be provided in accordance with the light emission sections 11, and the number of the light reception sections 31 is not limited.

### Second Exemplary Embodiment

In the first exemplary embodiment described above, all the light emission sections 11 of the light emitting unit 10 are configured to emit light of different frequencies. In contrast, a second exemplary embodiment is different from the first exemplary embodiment in that a plurality of light emission sections 11 emit light of the same frequency.

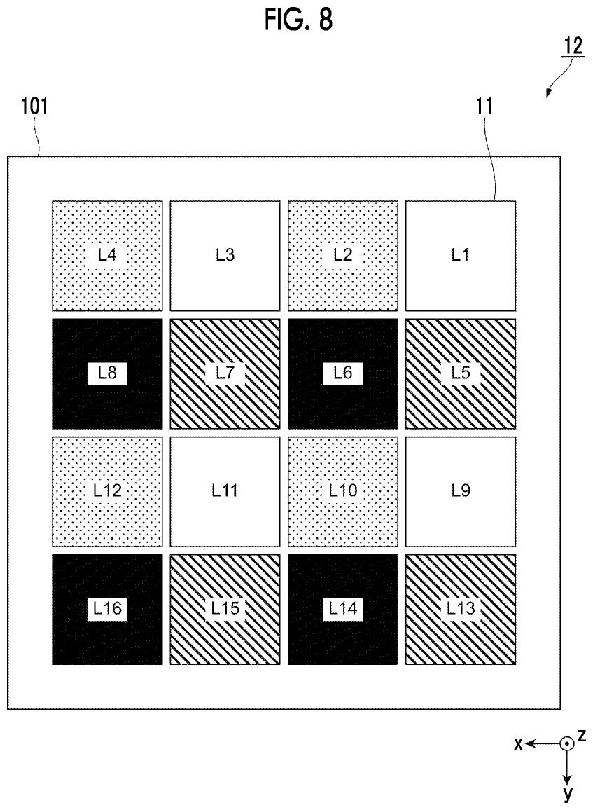

FIG. 8 is a diagram illustrating an example of a light emitting unit 12 according to the second exemplary embodiment. The left side of the paper surface is the +x direction, the lower side of the paper surface is the +y direction, and the front side of the paper surface is the +z direction. Portions similar to portions in FIGS. 2 and 3 are denoted by the same reference signs, and description thereof may be omitted.

In the example in FIG. 8, the light emitting unit 12 includes a total of 16 light emission sections 11 being 4 in the x-direction and 4 in the y-direction. Similar to FIG. 2, in a case where it is necessary to distinguish the light emission sections 11 from each other, the light emission sections 11 are distinguished as light emission sections L1 to L16 in order from the upper right side (ends in the −x direction and −y direction).

FIG. 8 also illustrates that the light emission sections 11 shown in the same pattern emit light of the same frequency, and the light emission sections 11 shown in different patterns emit light of different frequencies. For example, the light emission section L1 and the light emission sections L3, L9, and L11 emit light of the same frequency. Also, for example, the light emission section L1 and the light emission sections L2, L5, and L6 emit light of different frequencies.

As illustrated in FIG. 8, in the light emitting unit 12 according to the second exemplary embodiment, the plurality of light emission sections 11 emit light of the same frequency, and the light emission sections 11 that emit light of the same frequency are arranged so as not to be adjacent to each other. For example, the light emission section L7 emits light of the same frequency as the frequencies in the light emission sections L5, L13, and L15 that are not adjacent, but emits light of different frequencies from the frequencies of the light emission sections L3, L6, L8, and L11 that are adjacent to the light emission section L7.

In other words, in the second exemplary embodiment, the total number of light emission sections 11 in the light emitting unit 12 is more than the total number of frequencies used in light emission of the light emitting unit 12. In the example in FIG. 8, the total number of light emission sections 11 in the light emitting unit 12 is 16, and the total number of frequencies of light emitted by the light emitting unit 12 is 4.

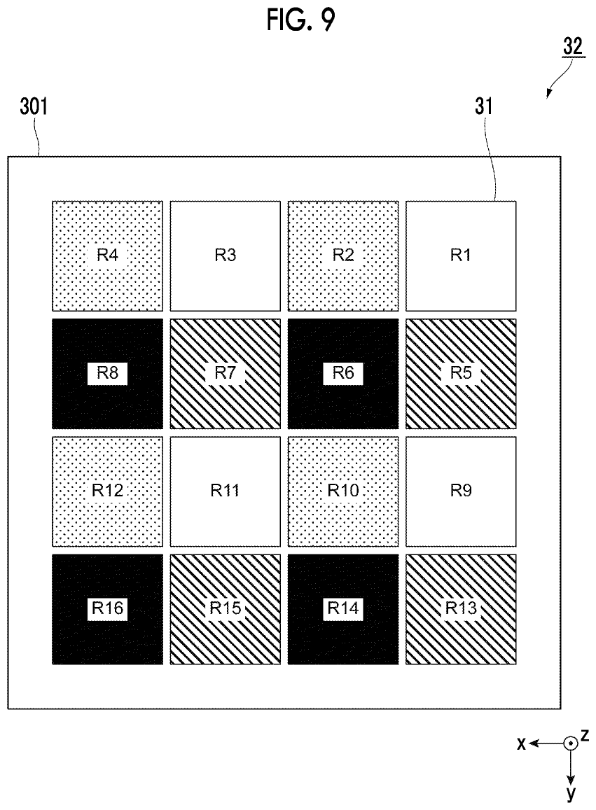

FIG. 9 is a diagram illustrating an example of a light receiving unit 32 according to the second exemplary embodiment. The left side of the paper surface is the +x direction, the lower side of the paper surface is the +y direction, and the front side of the paper surface is the +z direction. Similar to FIG. 4, in a case where it is necessary to distinguish the light reception sections 31 from each other, the light reception sections 31 are distinguished as light reception sections R1 to R16 in order from the upper right side (ends in the −x direction and −y direction). FIG. 9 illustrates that, for the light reception sections 31 shown in the same pattern, the light reception result includes the result obtained by receiving light of the same frequency, and for the light reception sections 31 shown in different patterns, the light reception result includes the result obtained by receiving light of the different frequencies. In FIGS. 8 and 9, the light emitted by the light emission sections 11 shown in the same pattern, and the light used in the light reception result of the light reception section 31 have the same frequency.

As illustrated in FIG. 9, in the light receiving unit 32, each light reception section 31 receives light of the frequency of light emitted by the corresponding light emission section 11 (see FIG. 8), and obtains the light reception result. In the light receiving unit 32 according to the second exemplary embodiment, adjacent light reception sections 31 are configured to receive light of different frequencies as light reception results.

In addition, in the second exemplary embodiment, the total number of light reception sections 31 in the light receiving unit 32 is more than the total number of frequencies used in the light reception result in the entirety of the light receiving unit 32. In the example in FIG. 9, the total number of light reception sections 31 in the light receiving unit 32 is 16, and the total number of frequencies used in the light reception result in the entirety of the light receiving unit 32 is 4.

Also in the second exemplary embodiment described above, as in the first exemplary embodiment, the adjacent light emission sections 11 emit light of the different frequencies, and the adjacent light reception sections 31 obtain the result obtained by receiving the light of the different frequencies, as the light reception result. As a result, for example, even though light from the light emission sections L3, L6, L8, and L11, which tend to enter into the light reception section R7, is received by the photodiodes PD in the light reception section R7, the result of such light reception is not included in the light reception result, and thus generation of noise is suppressed. Therefore, even in a distance measurement system to which the second exemplary embodiment is applied, deterioration in distance measurement accuracy is suppressed as compared with the conventional distance measurement system 1′.

In the examples in FIGS. 8 and 9, a configuration in which four frequencies are used so that a certain light emission section 11 and adjacent light emission sections 11 in the ±x and ±y directions emit light of different frequencies has been made. In the second exemplary embodiment, the adjacent light emission sections 11 may emit light of different frequencies, and the total number of frequencies of emitted light is not limited.

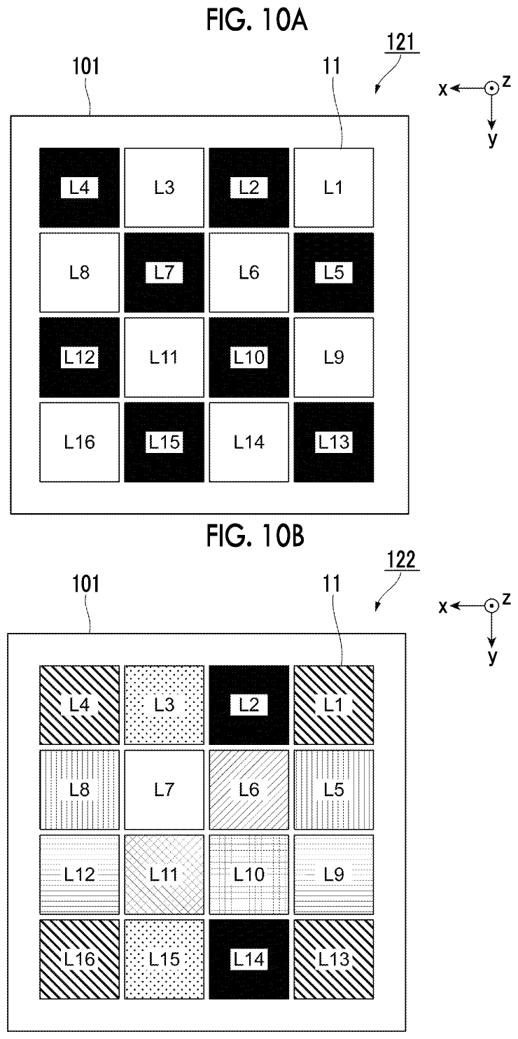

FIGS. 10A and 10B are diagrams illustrating light emitting units 121 and 122 as another example of the light emitting unit 12 according to the second exemplary embodiment. FIG. 10A illustrates an example in which a certain light emission section 11 and adjacent light emission sections 11 in the ±x and ±y directions emit light of different frequencies. FIG. 10B illustrates an example in which a certain light emission section 11 and the surrounding light emission sections 11 emit light of different frequencies. In FIGS. 10A and 10B, the left side of the paper surface is the +x direction, the lower side of the paper surface is the +y direction, and the front side of the paper surface is the +z direction. FIGS. 10A and 10B illustrates that the light emission sections 11 shown in the same pattern emit light of the same frequency, and the light emission sections 11 shown in different patterns emit light of different frequencies.

In a case where all the light emission sections 11 are arranged to have the same rectangular shape, by alternately arranging two frequencies as in the light emitting unit 121 illustrated in FIG. 10A, the adjacent light emission sections 11 can be configured to emit light of different frequencies. However, by using four frequencies as in the light emitting unit 12 illustrated in FIG. 8, the adjacent light emission sections 11 can be configured to emit light of different frequencies regardless of the shape or the arrangement of the light emission sections 11.

Further, the light emitting unit 122 illustrated in FIG. 10B is configured such that a certain light emission section 11 and the surrounding light emission sections 11 emit light of different frequencies. More specifically, the light emission sections 11 adjacent to a certain light emission section 11 in the ±x and ±y directions and the light emission sections 11 located diagonally are configured to emit light of different frequencies. In this case, since the light emission sections 11 that emit light of the same frequency are arranged to be further apart from each other, the deterioration in distance measurement accuracy is suppressed as compared with the case where a certain light emission section 11 and the light emission sections 11 located diagonally emit light at the same frequency.

### Third Exemplary Embodiment

A third exemplary embodiment is different from the first and second exemplary embodiments in that the light emission section 11 is driven for each drive section D (described later) including a plurality of light emission sections 11.

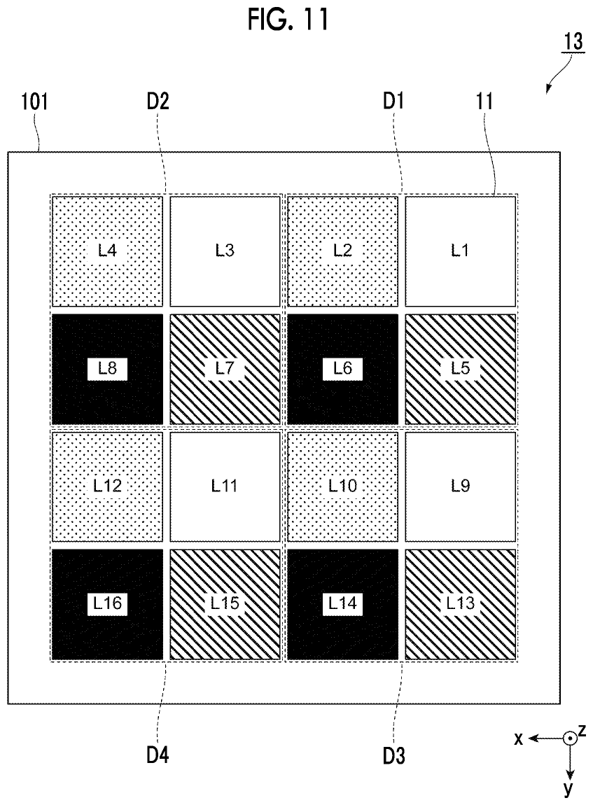

FIG. 11 is a diagram illustrating an example of a light emitting unit 13 according to the third exemplary embodiment. In FIG. 11, the left side of the paper surface is the +x direction, the lower side of the paper surface is the +y direction, and the front side of the paper surface is the +z direction.

As illustrated in FIG. 11, the light emitting unit 13 according to the third exemplary embodiment includes a drive section including a plurality of light emission sections 11.

In the example in FIG. 11, the light emitting unit 13 includes drive sections D1, D2, D3, and D4, each consisting of four light emission sections 11. More specifically, the light emitting unit 10 includes a drive section D1 consisting of light emission sections L1, L2, L5, and L6, a drive section D2 consisting of light emission sections L3, L4, L7, and L8, a drive section D3 consisting of light emission sections L9, L10, L13, and L14, and a drive section D4 consisting of light emission sections L11, L12, L15, and L16.

The light emission sections 11 in one drive section D are configured to emit light at different frequencies. In addition, the drive section D includes the light emission sections 11 that emit at the same frequency. For example, the drive sections D1, D2, D3, and D4 include the light emission sections L1, L3, L9, and L11 that emit at the same frequency, respectively.

In distance measurement, the drive sections D1, D2, D3, and D4 are driven at different timings. For example, the drive sections D2 to D4 are not driven while the drive section D1 is driven, and the drive sections D1, D2, and D4 are not driven while the drive section D3 is driven.

Therefore, in distance measurement, the light emission sections 11 that emit light at the same frequency emit light at different timings. For example, the light emission section L1 emits light at a timing different from the light emission sections L3, L9, and L11. As a result, the light reception section R1 (not illustrated) corresponding to the light emission section L1 receives light from the light emission section L1, but does not receive light from the light emission sections L3, L9, and L11. Thus, noise generation in the light reception result is suppressed. That is, even in a distance measurement system using the light emitting unit 13 according to the third exemplary embodiment, deterioration in distance measurement accuracy is suppressed as compared with the conventional distance measurement system 1′.

The number of light emission sections 11 in the drive section D is not limited, as long as one or more light emission sections 11 are included. In a case where the drive section D includes two or more light emission sections 11, the light emission sections 11 in one drive section D may be configured to emit light at different frequencies.

Further, because the drive section D is configured to include the light emission sections 11 corresponding to all the frequencies of light emitted from the light emitting unit 13, complication of the light emitting unit 13 is suppressed. For example, in the example in FIG. 11, each drive section D includes light emission sections 11 respectively corresponding to four frequencies, which corresponds to the point that the light emitting unit 13 emits light of four frequencies.

### Fourth Exemplary Embodiment

In the first to third exemplary embodiments described above, the light emission section 11 in the light emitting unit 10, the radiation section 51 in the radiation surface 50, and the light reception section 31 in the light receiving unit 30 are all configured to correspond to each other. A fourth exemplary embodiment is different from the first to third exemplary embodiments in that the light emission section 11 in a light emitting unit 14 is not provided corresponding to the radiation section 51 and the light reception section 31. More specifically, by using a diffractive optical element (DOE), light from a certain light emission section 11 is branched and radiated to a plurality of radiation sections 51, and the total number of light emission sections 11 is less than the total number of radiation sections 51 and the total number of light reception sections 31.

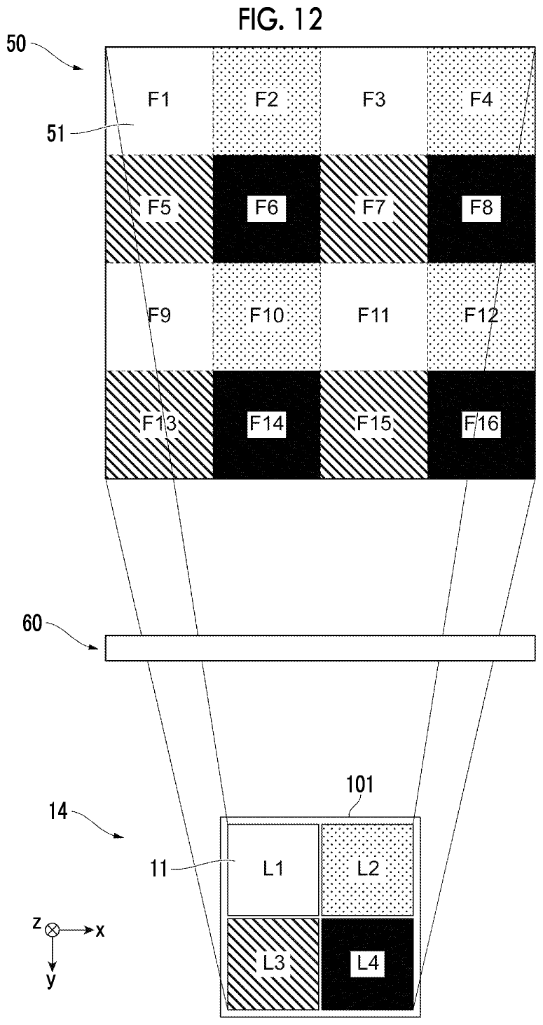

FIG. 12 is a diagram illustrating an example of the light emitting unit 14 according to the fourth exemplary embodiment.

As illustrated in FIG. 12, the light emitting unit 14 according to the fourth exemplary embodiment includes a substrate 101, a light emission section 11, and a diffractive optical element 60. The light emitting unit 14 includes four light emission sections 11 that emit light of frequencies different from each other. Light from each light emission section 11 is branched by the diffractive optical element 60 and is radiated to a plurality of radiation sections 51. For example, the light from the light emission section L1 is branched into four rays of light and radiated to radiation sections F1, F3, F9, and F11. The diffractive optical element 60 is configured to branch the light from one light emission section 11 and emit the branched light toward the radiation sections 51 that are not adjacent to each other.

16 light reception sections 31 of the light receiving unit in the fourth exemplary embodiment are provided corresponding to the radiation sections 51. More specifically, the light reception section 31 is configured to output, as the light reception result, the result obtained by receiving the light of the frequency radiated toward the corresponding radiation section 51.

Also in the fourth exemplary embodiment described above, as in the first to third exemplary embodiments, the deterioration in distance measurement accuracy in a case where light from the radiation section 51 adjacent to the corresponding radiation section 51 enters into a certain light reception section 31 is suppressed. For example, in a case where light from the radiation section F7 and light from the radiation sections F3, F6, F8, and F11 adjacent to the radiation section F7 enter into the light reception section R7 (not illustrated) corresponding to the radiation section F7, a result obtained by receiving the light from the radiation section F7 is output, and a result obtained by receiving the light from the radiation sections F3, F6, F8, and F11 is not output, as the light reception result of the light reception section R7. Therefore, the noise generation in the light reception result is suppressed, and the deterioration in distance measurement accuracy is suppressed as compared with the conventional distance measurement system 1′.

In the fourth exemplary embodiment as described above, it is possible to perform radiation to radiation sections 51 of which the number is more than the number of light emission sections 11, and to widen a range set as a measurement target, as compared with the case where the diffractive optical element 60 is not provided.

In the example in FIG. 12, a configuration in which the total of four light emission sections 11 are provided one for each frequency, and the light from each light emission section 11 is branched into four radiation sections 51, and thus light is radiated to the total of 16 radiation sections 51 has been made. However, the number of branches is not limited as long as the light from one light emission section 11 is branched to two or more radiation sections 51.

### Modification Examples and Like

In the first to third exemplary embodiments described above, the description has been made on the assumption that the light emission sections Li are independently driven by light emission drive unit 20-i. That is, the description has been made on the assumption that all the light emission sections 11 are independently driven and emit light by providing the respective light emission drive units 20-i corresponding to all the light emission sections 11.

However, in a case where light of the same frequency is emitted from a plurality of light emission sections 11 as in the second and third exemplary embodiments, the light emission sections 11 that emit light at the same frequency may be driven by the common (one) light emission drive unit 20. That is, at least one light emission drive unit 20 only needs to be provided for each frequency used for light emission of the light emitting units 12 and 13. For example, in the example in FIG. 8, the light emission sections L1, L3, L9, and L11 may be driven by the common light emission drive unit 20-A, and the light emission sections L2, L4, L10, and L12 may be driven by the common light emission drive unit 20-B.

Furthermore, the case using a VCSEL as a light emitting element has been described as an example, but a light emitting diode LED, a laser diode LD, or the like may be used instead of the VCSEL.

Furthermore, although the case of using a photodiode as a light receiving element has been described as an example, a phototransistor or the like may be used instead of the photodiode.

In the first to fourth exemplary embodiments described above, the configuration in which all the VCSELs provided in the light emitting units 10, 12, 13, 121, and 122 are arranged on the common substrate 101 has been made. In other words, the light emitting units 10, 12, 13, 121, and 122 are configured by a so-called one chip (single chip). The light emitting units 10, 12, 13, 121, and 122 may be configured by so-called multi-chips, and may be arranged on different substrates 101 for each light emission section 11, for example.

Although the exemplary embodiments of the present invention have been described above, the technical scope of the present invention is not limited to the scope described in the above exemplary embodiments. It is obvious that combinations of two or more of the above exemplary embodiments and various modifications or improvements to the above exemplary embodiments are also included in the technical scope of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A distance measurement system comprising:
a light emitting unit that includes a first light emission section and second light emission section including light emitting elements;
a drive unit that causes light of a first frequency to be emitted from the first light emission section and causes light of a second frequency to be emitted from the second light emission section;
a light receiving unit that includes light receiving element, a first light reception section, and a second light reception section, the first light reception section including a light receiving element that receives at least the light of the first frequency, and the second light reception section including a light receiving element that receives at least the light of the second frequency; and
a distance measurement unit that measures a distance from a target object from a time from reflection of light radiated from the light emitting unit by the target object to reception of the light by the light receiving unit, by a time-of-flight phase difference method.

2. The distance measurement system according to claim 1,
wherein the drive unit causes the light of the first frequency to be emitted from a plurality of the first light emission sections, and
a total number of the light emission sections is more than a total number of frequencies of light emitted from the light emitting unit.

3. The distance measurement system according to claim 1,
wherein the light emitting unit includes three or more light emission sections, and
the drive unit causes light of different frequencies to be emitted from the light emission sections.

4. The distance measurement system according to claim 1,
wherein the drive unit drives all the light emission sections in the same period.

5. The distance measurement system according to claim 2,
wherein the drive unit drives all the light emission sections in the same period.

6. The distance measurement system according to claim 3,
wherein the drive unit drives all the light emission sections in the same period.

7. The distance measurement system according to claim 1,
wherein the drive unit
divides the light emission section of the light emitting unit into a plurality of drive sections and performs driving for each drive section, and
in a case where the drive section includes two or more light emission sections, drives the two or more light emission sections to emit light of different frequencies.

8. The distance measurement system according to claim 7,
wherein the drive section includes a plurality of the light emission sections corresponding to all frequencies of light emitted from the light emitting unit.

9. The distance measurement system according to claim 1, further comprising:
a diffractive optical element that is provided on an optical path of the light emitting unit, and branches light emitted by the light emitting unit.

10. A light emitting device that radiates light at a plurality of frequencies, the device comprising:
a plurality of light emission sections including light emitting elements,
wherein each of the plurality of light emission sections includes a connection terminal connected to a drive unit that performs driving at any one of the plurality of frequencies.

11. A light receiving device that receives light of a plurality of frequencies, the device comprising:
a plurality of light reception sections including light receiving elements that receive light of a plurality of frequencies,
wherein the light reception section outputs a result of receiving light of one frequency allocated to the light reception section.
